(19) United States
(12) Patent Application Publication
(10) Pub. No.: US 2012/0101866 A1
(43) Pub. Date: Apr. 26, 2012

(54) SERVICE LEVEL AGREEMENT DESIGN AND ENFORCEMENT FOR OUTSOURCED CALL CENTER

(75) Inventor: Richard K. Magnuson, Bellevue, WA (US)

(73) Assignee: COMPTER ASSOCIATES THINK, INC., Islandia, NY (US)

(21) Appl. No.: 13/343,775

(22) Filed: Jan. 5, 2012

Related U.S. Application Data
(63) Continuation of application No. 11/133,955, filed on May 20, 2005.
(60) Provisional application No. 60/573,564, filed on May 21, 2004.

(51) Int. Cl. G06Q 10/06

(52) U.S. Cl. 705/7.13

(57) ABSTRACT

A method for managing support services includes storing one or more support level agreements (SLAs), each having an associated attribute, in a database as one or more corresponding data objects. One or more trouble tickets, each having one or more associated attributes, are entered into the database as one or more corresponding data objects. One or more of the one or more stored SLAs are automatically applied to each of the one or more trouble tickets by matching the attributes of the one or more trouble tickets with the attributes of the one or more SLAs.

### REFERENCE TO RELATED APPLICATION

The present application is based on and claims the benefit of provisional application Ser. No. 60/573,564, filed May 21, 2004, the entire contents of which are herein incorporated by reference.

### BACKGROUND

1. Technical Field

The present disclosure relates to service level agreements and, more specifically, to service level agreement design and enforcement for outsourced call center.

2. Description of the Related Art

Support organizations are organizations that render support, for example, technical support. Support organizations may utilize centers and/or service desks. It is increasingly common for enterprises to enter into service contracts with support organizations. Support organizations often negotiate contracts describing the exact level of service their clients can expect. These service contracts may include multiple requirements that detail what services the support organization has agreed to provide the client. These requirements are commonly known as Service Level Agreements (SLAs). For example, SLAs may define what types of issues the support organization is to deal with. The SLAs may also establish expected response times. Additionally, SLAs commonly contain provisions for penalties, for example pecuniary penalties, that may be imposed for violations of the SLA.

Support organizations commonly utilize specialized software packages for issue tracking. These software packages are often referred to as incident/problem tracking software, call center, service desk or trouble ticket applications. This software may manage problems or service requests by the client. The software may also enforce the SLA and track related metrics, such as average response times, number of SLA violations, etc.

It is increasingly common for enterprises to outsource support services to professional support organizations. These professional support organizations often enter into SLAs with multiple organizations.

Support software packages may be able to handle SLAs for multiple organizations. Such support software packages may track discrete issues as “trouble tickets.” Support software packages may use a “matrix” to match a trouble ticket to a SLA so that the support organization can readily determine the proper level of support to use in handling the trouble ticket. The matrix may be a conceptual grid with a list of organizations on one axis and ticket attributes (e.g. priority, category, etc.) on the other axis. The support center administrator may define the appropriate SLA for each intersection. A ticket may then be connected with the appropriate SLA by locating the ticket on the matrix.

Support software packages utilizing the SLA matrix often utilize the SLA matrix to determine a single SLA that is applicable to a ticket. These packages have disadvantages. For example, populating and maintaining the matrix can be exceedingly burdensome as clients and attributes are added.

There is therefore a need for a unified solution for implementing SLA support for multiple organizations that is effective and efficient.

### SUMMARY

A method for managing support services includes storing one or more support level agreements (SLAs), each having an associated attribute, in a database as one or more corresponding data objects. One or more trouble tickets, each having one or more associated attributes, are entered into the database as one or more corresponding data objects. One or more of the one or more stored SLAs are automatically applied to each of the one or more trouble tickets by matching the attributes of the one or more trouble tickets with the attributes of the one or more SLAs.

A system for managing support services includes a database for storing one or more support level agreements (SLAs), each having an associated attribute, in a database as one or more corresponding data objects. An interface for entering one or more trouble tickets, each having one or more associated attributes, into the database as one or more corresponding data objects. An application unit for automatically applying one or more of the one or more stored SLAs to each of the one or more trouble tickets by matching the attributes of the one or more trouble tickets with the attributes of the one or more SLAs.

A computer system includes a processor and a computer recording medium including computer executable code executable by the processor for managing support services. The computer executable code includes code for storing one or more support level agreements (SLAs), each having an associated attribute, in a database as one or more corresponding data objects. code for entering one or more trouble tickets, each having one or more associated attributes, into said database as one or more corresponding data objects and code for automatically applying one or more of said one or more stored SLAs to each of said one or more trouble tickets by matching said attributes of said one or more trouble tickets with said attributes of said one or more SLAs.

A computer recording medium includes computer executable code for managing support services. The computer executable code includes code for storing one or more support level agreements (SLAs), each having an associated attribute, in a database as one or more corresponding data objects, code for entering one or more trouble tickets, each having one or more associated attributes, into said database as one or more corresponding data objects and code for automatically applying one or more of said one or more stored SLAs to each of said one or more trouble tickets by matching said attributes of said one or more trouble tickets with said attributes of said one or more SLAs.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram illustrating an example of an SLA Template according to an embodiment of the present disclosure;

FIG. 2 is a block diagram illustrating an example of an SLA Rule Template according to an embodiment of the present disclosure;

FIG. 3 is a block diagram illustrating an example of a Ticket Template according to an embodiment of the present disclosure;

FIG. 4 is a block diagram showing an example of a reference template according to an embodiment of the present disclosure;

FIG. 5 is a block diagram showing an example of an Attached_SLA template according to an embodiment of the present disclosure;

FIG. 6 is a block diagram showing an example of a Service_Contract template according to an embodiment of the present disclosure;

FIG. 7 is a block diagram showing an example of an Attribute_Map template according to an embodiment of the present disclosure;

FIG. 8 is a block diagram showing an example of a contact template according to an embodiment of the present disclosure;

FIG. 9 is a block diagram showing an example of an organization template according to an embodiment of the present disclosure;

FIG. 10 is a flow chart illustrating how the data model may be used to provide support services according to an embodiment of the present disclosure;

FIG. 11 is a flow chart illustrating how SLAs may be applied to a ticket according to one embodiment of the present disclosure;

FIG. 12 is a flow chart illustrating a method for modifying an SLA when ticket attributes have been updated according to an embodiment of the present disclosure;

FIG. 13 is a flow chart illustrating a method for defining a default case according to one embodiment of the present disclosure;

FIG. 14 is a flow chart illustrating a process for evaluating the projected violation time of a ticket according to an embodiment of the present disclosure;

FIG. 15 is an example of a graphical user interface for displaying and/or receiving service contract details according to an embodiment of the present disclosure;

FIG. 16 is an example of a graphical user interface for displaying and/or receiving service contract details according to an embodiment of the present disclosure;

FIG. 17 is an example of a graphical user interface for displaying and/or receiving issue details according to an embodiment of the present disclosure;

FIG. 18 shows an example of a computer system capable of implementing the method and apparatus according to embodiments of the present disclosure.

### DETAILED DESCRIPTION

In describing embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present disclosure relate to methods for managing support organization services and computerized systems for performing these methods. Embodiments of the present disclosure may be adapted to conform to ITIL best practices maintained by the IT Service Management Forum (itSMF).

Attributes are classifiers that may be used to describe a trouble ticket. Examples of attributes may include affected organization, ticket priority, affected equipment, etc. Embodiments of the present disclosure allow for the examination of one or more service agreements between a service provider and one or more clients as a set of one or more SLAs. An SLA may then be assigned to each attribute. During runtime (the execution of the support software package), when a ticket is created, SLAs may be applied to the ticket thereby obviating the use of an SLA matrix.

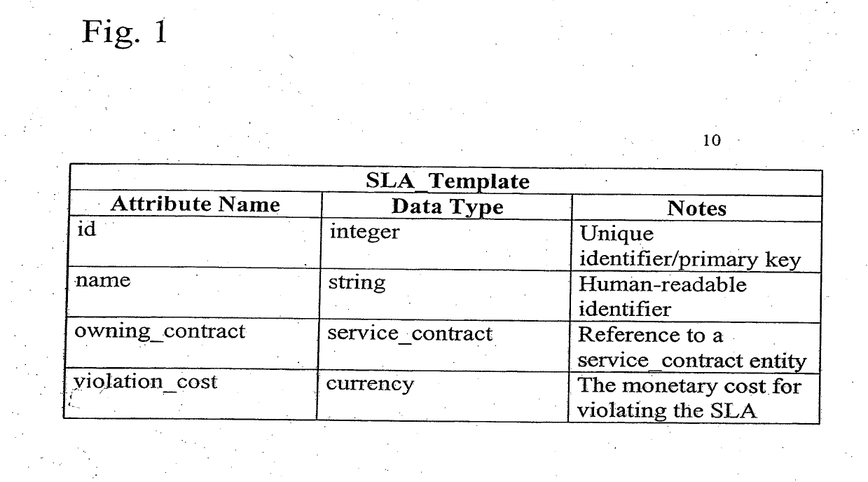

Embodiments of the present disclosure may utilize a data model. The data model is a way of organizing data relating to SLAs and SLA rules so that the SLA rules may be applied to each ticket. Within the data model, each SLA may occupy a data object. This SLA data object may accord with an SLA Template. FIG. 1 is a block diagram illustrating an example of an SLA Template according to an embodiment of the present disclosure. The SLA template 10 may include an “id” attribute. The “id” attribute may be of an integer data type. The “id” attribute may be used as a unique identifier and/or a primary key. For example, every SLA may have its own unique identifier. The SLA template 10 may also include a “name” attribute. The “name” attribute may be of a string data type. The “name” attribute may be a human-readable identifier, such as a written description of the SLA. The SLA template 10 may also include a “owning_contract” attribute. The “owning_contract” attribute may be of a service_contract data type. The service_contract data type being a data type capable of indicating which service contract the SLA is derived from. The SLA template 10 may also include a “violation_cost” attribute. The “violation_cost” attribute may be of a currency data type. The “violation_cost” attribute may indicate the pecuniary penalty associated with violating the given SLA. The SLA template 10 may additionally include other attributes as need be.

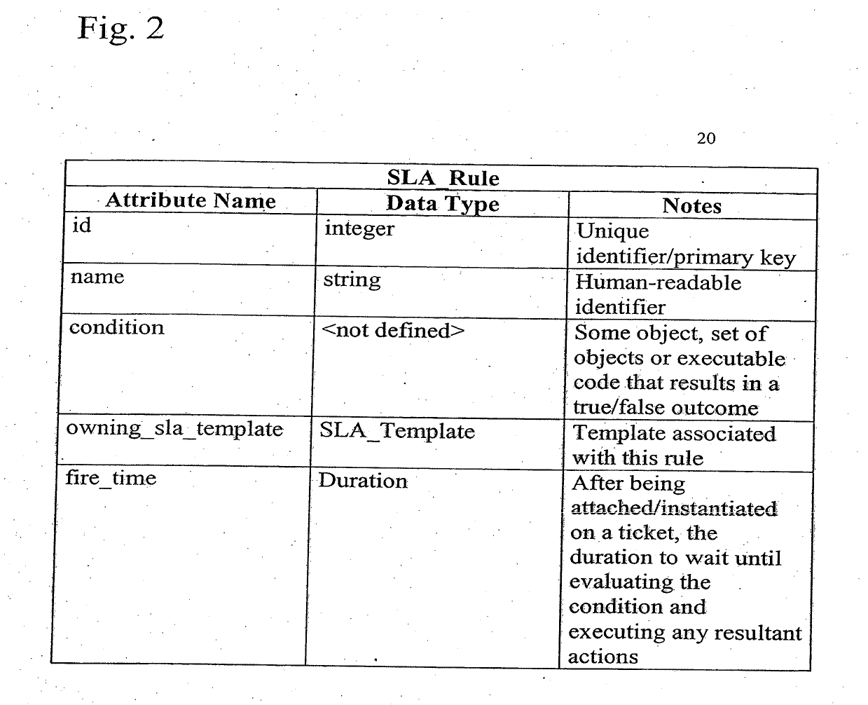

The data model may also include data objects for defining SLA rules. These SLA rule data objects may accord with an SLA Rule Template. FIG. 2 is a block diagram illustrating an example of an SLA Rule Template according to an embodiment of the present disclosure. The SLA Rule template 20 may include an “id” and “name” attributes that have been described above in relation to the SLA Template. The SLA Rule template 20 may also include a “condition” attribute. The condition may indicate what conditions are necessary to implement the given rule on a given ticket. For example, the condition may be an object, set of objects or executable code that may result in a true or false outcome. The SLA Rule Template 20 may include an “owning_sla_template” attribute. The “owning_sla_template” may be of an SLA_Template data type. The SLA data type may be a data type for storing the name of an SLA_Template. The “owning_sla_template” attribute may be used to reference the SLA Template corresponding to the SLA from which the particular rule is based. The SLA Rule template 20 may include a “fire_time” attribute of a “duration” data type. The duration data type may be a data type for storing a length of time. The “fire_time” attribute may be used to indicate the length of time to wait before evaluating the condition and executing any “actions” that may result from satisfaction of the condition.

“Actions” may be affirmative steps that may be executed. For example, actions may be initiated by rules. Actions may include, for example, sending notifications, escalating tickets, and setting the SLA violation of a ticket.

Embodiments of the present disclosure may utilize a Time to Violation (TTV) system to indicate how much time remains before a given ticket has violated an SLA. For example, if the SLA states that trouble tickets relating to printer problems should be addressed within 2 days, then the TTV may keep track of how much time remains within the 2 days for that given ticket. Tickets that have violated an SLA, for example by allowing the time to lapse without action, may be flagged by the TTV as a violation. For example, a flag may be placed on an Attached SLA object (for example, represented by the sla_status attribute) and/or the ticket.

As indicated above, the fire_time attribute of the SLA_Rule Template defines the delay between when the SLA_Template and the SLA_Rule Template are applied to the ticket and when the SLA_Rule is actually evaluated. This allows for the rule to initiate at some later point to assess if the SLA Rule, and hence the SLA, has been violated. For example, where the SLA Rule specifies that trouble tickets relating to printers may not remain open for longer than 4 days, the fire_time delay may be 4 days at which point the condition of whether the ticket has been closed may be evaluated. Where the condition is not met, an action may be performed and/or the SLA Rule flagged.

It may also be possible for conditions to be evaluated after the occurrence of some event rather than after the expiration of a fire_time. For example, a condition may be assessed when the priority of a ticket is changed. Such rules may be evaluated by a system other than the TTV system.

The trouble ticket may also be referred to as an incident, problem or request. The trouble ticket may form the basic unit of the support organization duties. As support requests are received, each request is broken down into one or more discrete tasks. Each task may be assigned a ticket. Each ticket may be stored in the data model as a Ticket template.

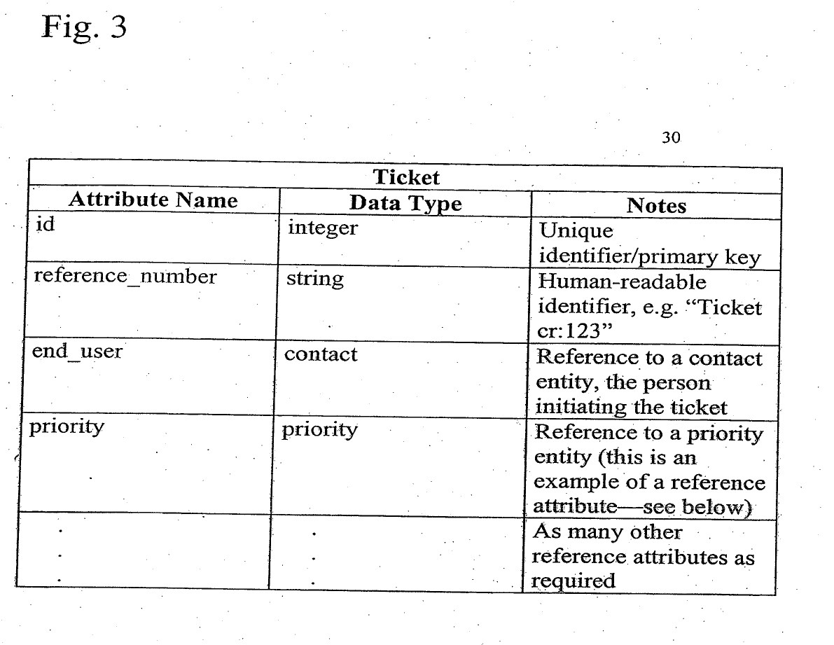

FIG. 3 is a block diagram illustrating an example of a Ticket Template according to an embodiment of the present disclosure. The Ticket Template 30 may include an “id” attribute. The “id” attribute may be of an integer data type. The “id” attribute may be used as a unique identifier and/or a primary key. The Ticket template 30 may include a “reference_number” attribute of the string data type. This attribute may be a human-readable identifier such as, for example, “Ticket cr:123.” The Ticket Template 30 may include an “end_user” attribute of a contact data type. The contact data type may be used to store a reference to a contact object. The end_user may be, for example, the person initiating the ticket, for example, the person placing the service request. The Ticket Template 30 may include a “priority” attribute of a priority data type. The priority data type may be a reference to a priority object. The priority attribute may be used to reference a priority object to the ticket. Priority objects are described below. The ticket template 30 may additionally include one or more other attributes that may be used to reference as many additional attributes as desired.

It may be possible for multiple tickets to share a common attribute. For example, all tickets may have a priority attribute. Where attributes are shared, a table may be utilized that encompasses all instances of that attribute. For example, a priority table object may be utilized to store the priority of all tickets. In the Ticket template 30, priority may therefore refer to the priority table object rather than simply store a priority value. Other examples of shared references may include end users/contacts, categories and assets/configuration items.

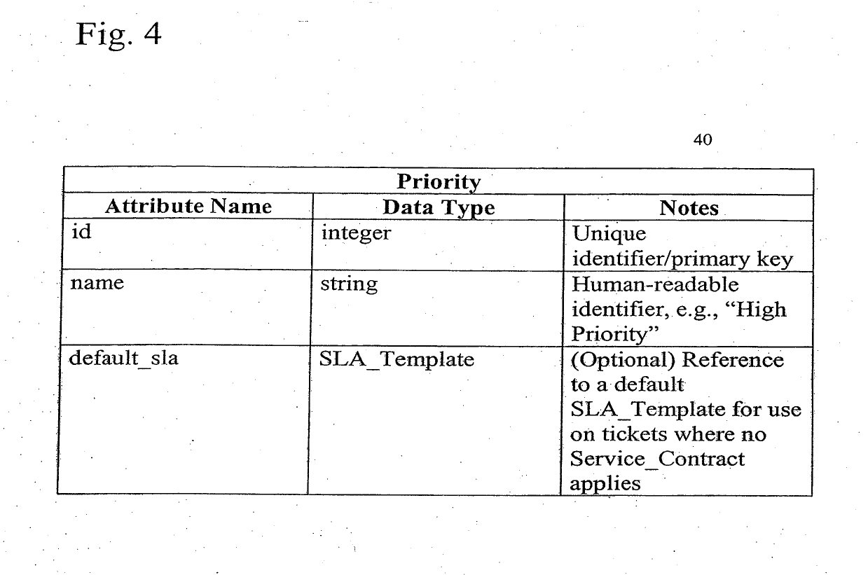

FIG. 4 is a block diagram showing an example of a reference template according to an embodiment of the present disclosure. Entries of the reference table object may follow such a template. Here the example reference template is for priority, but similar reference elements may be used for any other reference. The Priority reference template 40 may include an “id” and “name” attributes as described above. The name attribute may be used to indicate the priority level, for example “high priority.” The priority reference template 40 may also have a “default_sla” attribute of a “SLA_Template” data type. The SLA_Template attribute may reference a default SLA_Template for use on tickets where no Service_Contract is applied.

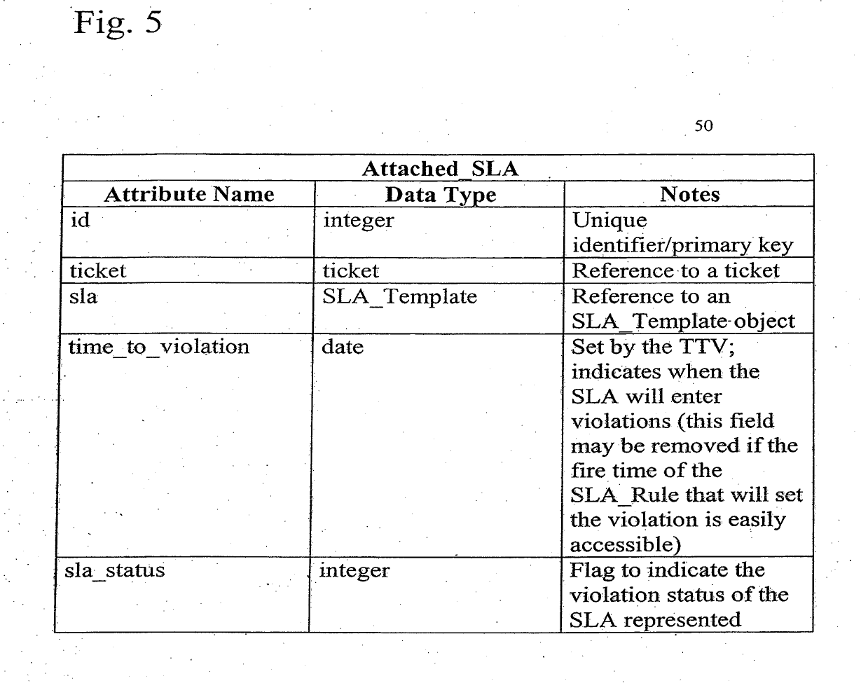

As described above, a single ticket instance may have multiple associated SLA. In the data model, an SLA may be attached to a ticket by maintaining Attached_SLA data objects that establish each attachment. The Attached_SLA data objects may adhere to an Attached_SLA template. FIG. 5 is a block diagram showing an example of an Attached_SLA template according to an embodiment of the present disclosure. The Attached_SLA template 50 may include an “id” attribute as described above. The Attached_SLA template 50 may include a “ticket” attribute of a suitable attribute type for referencing the ticket that is to be attached to an SLA. The Attached_SLA template 50 may include an “sla” attribute of a suitable data type for referencing an SLA that is to be attached to the ticket. The Attached_SLA template 50 may also include a “time_to_violation” attribute of a data type. This attribute may be set by the TTV system and may indicate when the SLA will enter violation. This attribute need not be used where the fire time of the SLA Rule that sets the violation can be easily accessed. The Attached_SLA template 50 may also include an SLA Status attribute, for example, of an integer data type, as a flag to indicate if the represented SLA has been violated.

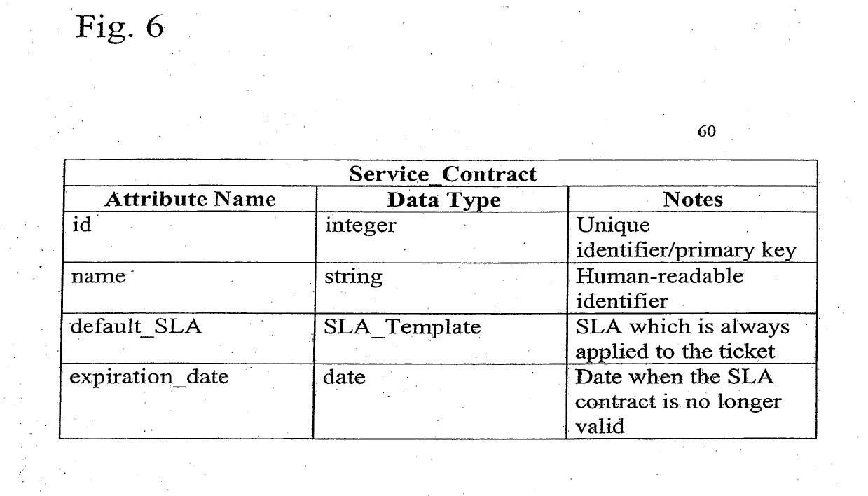

As described above, the service contract may include a collection of SLAs between a support organization and a client. Service contracts may be stored as objects in the data model, for example, using a Service_Contract template. FIG. 6 is a block diagram showing an example of a Service_Contract template according to an embodiment of the present disclosure. The Service_Contract template 60 may include an “id” attribute as described above. The Service_Contract template 60 may include a “name” attribute of a string data type for storing a human-readable name for the service contract. The Service_Contract template 60 may also include a “default SLA” attribute of a suitable data type for indicating which SLA_Template is to be applied to the ticket. The Service_Contract template 60 may also include an “expiration_date” attribute of a date data type for storing the date when the SLA expires, for example, when the service contract expires.

Each service_contract may maintain a collection of “private” SLA_Templates. The collection of private SLA_Templates may not be shown in the Service_Contract template 60 because the collection may be defined by an SQL query or some other dynamic collection mechanism. A single SLA_Template may be defined for each supported client. Multiple clients may not be able to use the same SLA_Template.

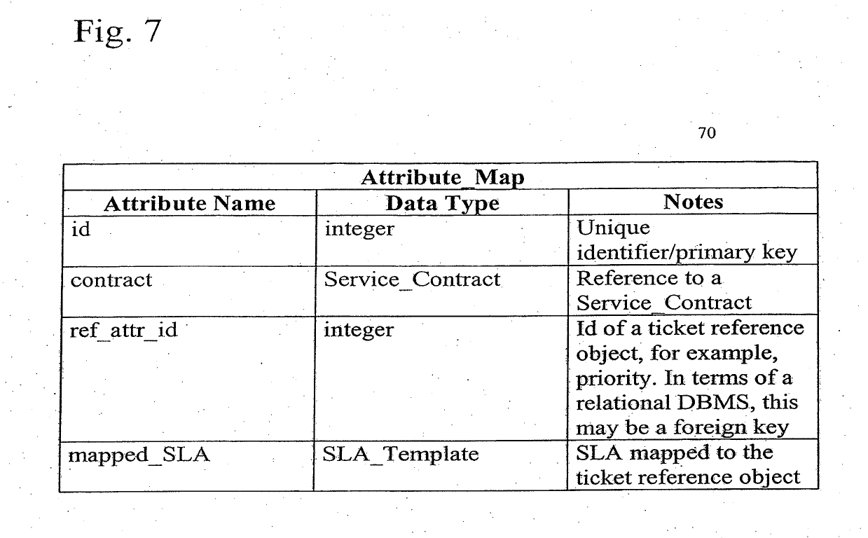

A Service_Contract may also maintain multiple collections of “attribute maps.” An attribute map may be an object that associates a shared ticket reference object, for example priority, and a private SLA_Template. Attribute maps may allow for defining different SLA behavior for tickets with shared reference fields. For example, “high priority” tickets for client ABC will employ different SLA rules than “high priority” tickets for client XYZ. Attribute maps may be simple three-way association classes. FIG. 7 is a block diagram showing an example of an Attribute_Map template according to an embodiment of the present disclosure. The Attribute_Map template 70 may include an “id” attribute as described above. The Attribute_Map template 70 may also include a “contract” attribute of a suitable data type for referencing a service contract. The Attribute_Map template 70 may also include a “ref_attr_id” attribute of a suitable data type for referencing a ticket reference object. For example, it may be an integer referencing the id of a ticket reference object, for example, priority. Where a relational DBMS is used, this field may be a foreign key. The Attribute_Map template 70 may also include a “mapped_SLA” attribute of a suitable data type for referencing the SLA that is mapped to the ticket reference object.

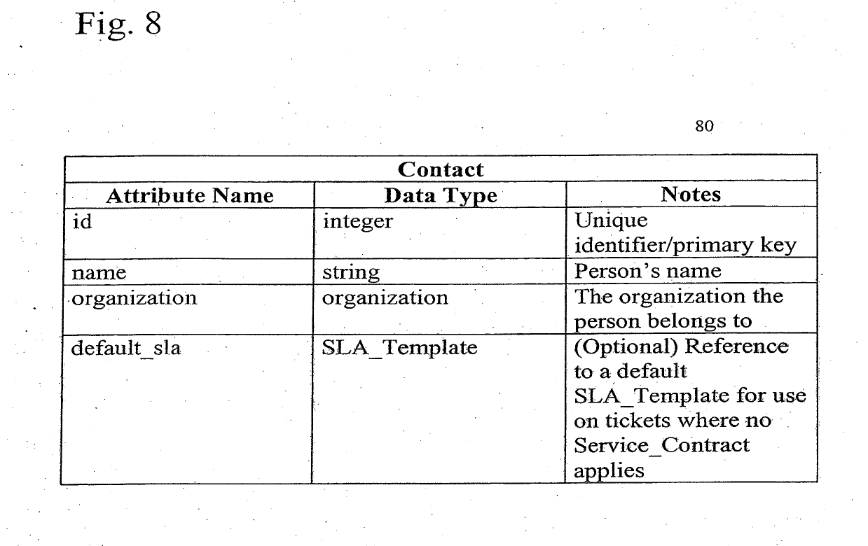

A service contact may represent a person or a group. The contact may be someone within the support organization or the contact may be someone affiliated with a supported client. Information pertaining to each contact may be stored in the data model as an object, for example, adhering to a contact template. FIG. 8 is a block diagram showing an example of a contact template according to an embodiment of the present disclosure. The contact template 80 may include an “id” attribute as described above. The contact template 80 may also include a “name” attribute of a suitable data type, for example, a string, for referencing a person's name. The contact template 80 may also include an “organization” attribute of a suitable data type for referencing the organization that the contact person belongs to. The contact template 80 may also have a “default_sla” attribute of a “SLA_Template” data type. The SLA_Template attribute may reference a default SLA_Template for use on tickets where no Service_Contract is applied.

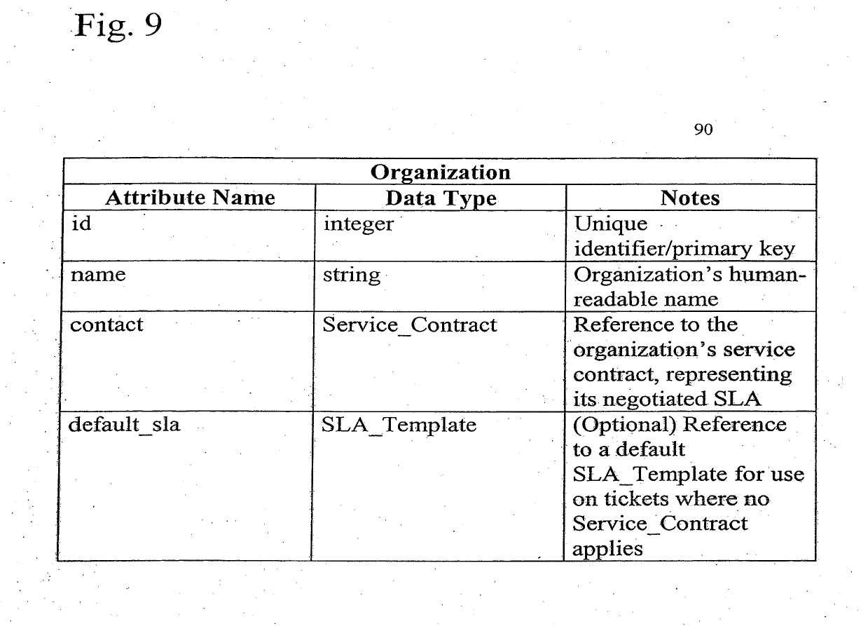

An organization may be a client supported by the support organization. For example, the organization may be a company, a division within a company or even a class of people (for example, “new customers”). The organization may be the supported object which has negotiated one or more service level agreements with the support organization. Information pertaining to each organization may be stored in the data model as an object, for example, adhering to an organization template. FIG. 9 is a block diagram showing an example of an organization template according to an embodiment of the present disclosure. The organization template 90 may include an “id” attribute as described above. The organization template 90 may also include a “name” attribute of a suitable data type, for example, a string, for referencing an organization's name. The organization template 90 may also include a “contract” attribute of a suitable data type for referencing the organization's service contract where the organizations SLAs were negotiated. The organization template 90 may also have a “default_sla” attribute of a “SLA_Template” data type. The SLA_Template attribute may reference a default SLA_Template for use on tickets where no Service_Contract is applied.

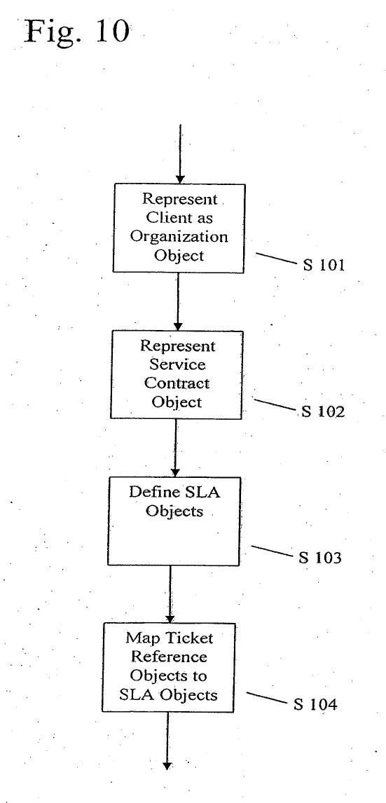

The data model described above may be used to facilitate execution of embodiments of the present disclosure. FIG. 10 is a flow chart illustrating how the data model may be used to provide support services according to an embodiment of the present disclosure. Each client organization may have an SLA. A company or division may be represented as an organization object, for example, according to the organization template described above (Step S101). Service contract objects, for example, according to the service_contract template described above, may be used to represent the collection of SLAs associated with each organization object (Step S102). The service contract objects may define a set of SLA Templates that are “private” to the contract. The SLA objects may be defined, for example according to the SLA_template described above (Step S103). The SLA objects may define the rules, events, etc. that implement the terms of the service level agreements.

The support organization administrator, for example a call center administrator, may map ticket reference objects to the SLA objects (Step S104). This may be accomplished by generating attribute map objects, for example according to the Attribute_Map template described above. Each ticket reference object may be associated with its own SLA. The data model may generate the attribute map objects based on the supported organization. For example, the rules for “high priority” tickets for client ABC may be different than the rules for “high priority” tickets for client XYZ.

SLA features may be dynamic. A dynamic SLA feature is where the rules of an SLA may change for a particular contact. For example, an organization's CEO may have a more urgent SLA than other contacts within the same organization.

Because multiple SLAs may be applied to a single ticket, a single ticket may meet one SLA and violate another. For example, where a ticket is generated for a broken printer and a priority level of 3, both a printer SLA and a priority 3 SLA may be applied to the ticket. As each SLA may enforce different resolution times, it is possible to meet one SLA and violate another.

When a ticket is generated, the rules and restrictions of the appropriate SLAs may be applied. For example, multiple SLA objects may be applied to the ticket. Zero or more SLA objects may be applied to the ticket according to the service_contract object of the relevant organization. This may be the organization associated with the ticket's end user. Alternatively the ticket may be assembled according to a service contract of the end user directly. The SLAs associated with a ticket may then be viewed, for example, by viewing the Attached_SLA objects. The aggregate of the rules and events of all SLA_Templates associated to a ticket via Attached_SLA items may be thought of as a single composite SLA.

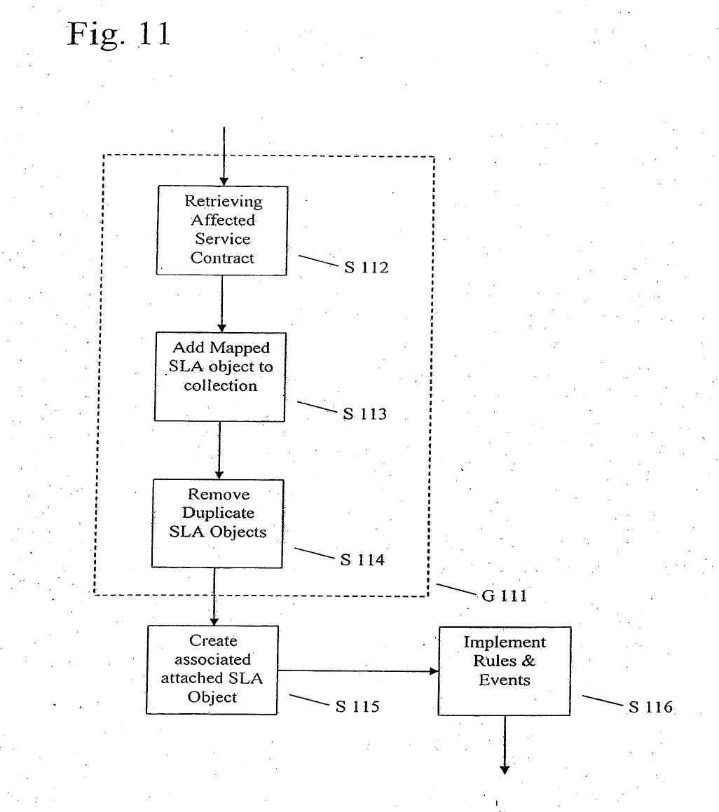

As described above, zero or more SLAs may be applied to a single ticket. FIG. 11 is a flow chart illustrating how SLAs may be applied to a ticket according to one embodiment of the present disclosure. When a new ticket is created, applicable SLA objects are collected (Group of Steps 111). This may be accomplished by determining the affected organization of the ticket and retrieving its service_contract object (Step S112). The affected organization may be identified from the organization field of the contact end user on the ticket. If the ticket has no affected organization, or the organization has no service contract, the default case may be used. Each reference attribute of the ticket may be considered and if an attribute map object exists that relates the reference attribute object to the service_contract object, the mapped SLA object may be added to the collection (Step S113). Duplicate SLA objects may then be eliminated from the collection (Step S114).

An Attached_SLA object may then be created and associated with the ticket for each SLA object within the collection (Step S115). The rules and events defined in each SLA object may be implemented (Step S116). Here duplicate rules and/or events may be eliminated.

After the execution of the above described steps, the SLA objects associated with the ticket via Attached_SLA objects define the entire SLA for the ticket.

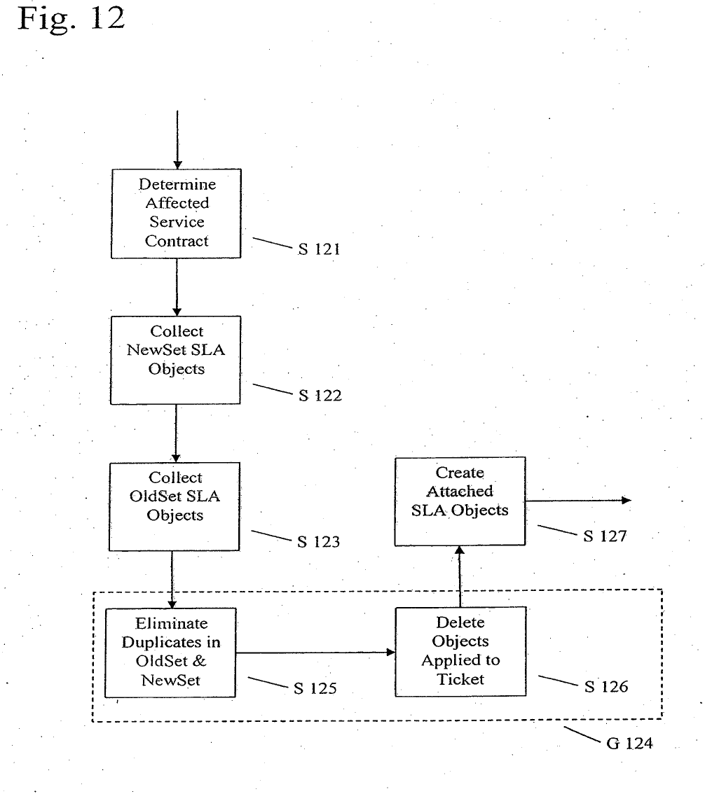

The attributes of a ticket may be updated. Updating the attributes of a ticket may then lead to adding and/or removing SLA objects from the ticket. FIG. 12 is a flow chart illustrating a method for modifying an SLA when ticket attributes have been updated according to an embodiment of the present disclosure. The ticket's affected organization and service contract may be determined (Step S121). Where no service contract is found a default case may be used. Applicable SLA objects may be collected (Step S122). The applicable SLA objects are those SLA objects that are applicable in light of the updated attributes (the NewSet). The existing SLA objects attached to the ticket via the Attached_SLA objects may be collected (Step S123). These SLA objects are those SLA objects that were applicable to the ticket prior to modification (the OldSet). The OldSet of SLA objects may be compared to the NewSet of SLA objects and the sets may be “pruned” (Group of Steps 124). Pruning the sets may include eliminating any duplicates (Step S125) and where an SLA object is found in the OldSet but not the NewSet, the existing Attached_SLA object and any outstanding rules/events the SLA object applied to the ticket may be deleted (Step S126). An Attached_SLA object may be created for each SLA object remaining in the NewSet (Step S127). Rules/events defined in the final set of Attached_SLA objects may then be enforced.

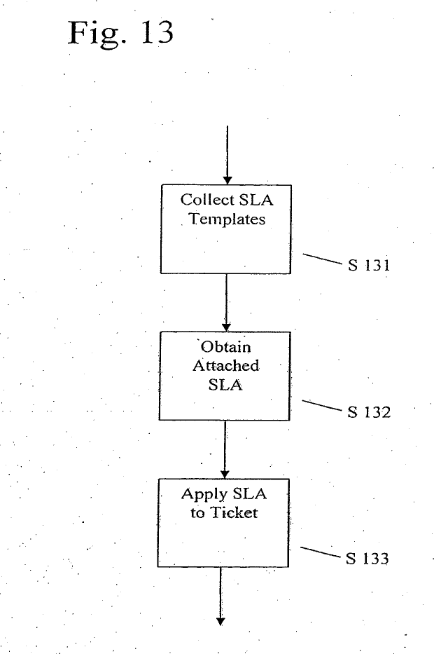

As described above, a default case may be used where no service contract applies. For example the default case may be used when a ticket has no affected organization, or the organization's contract is inactive or missing. For example the default case may be used when handling new contacts, for example, end-users, not yet assigned to an organization. The default case may be applied both for the creation of new tickets and updates. FIG. 13 is a flow chart illustrating a method for defining a default case according to an embodiment of the present disclosure. All applicable SLA_Templates may be collected (Step S131). This may include iterating through each reference attribute on a ticket, for example, priority, category, etc. Where the reference attribute is assigned an SLA Template (the “default SLA” field), the ticket may be added to the collection. For each ticket with the SLA_Template, an Attached_SLA may be obtained (Step S132). SLAs may now be applied to the ticket (Step S133), for example, using the method described above and illustrated in FIG. 11. Updating tickets may then be accomplished, for example, using the method described above and illustrated in FIG. 12.

Embodiments of the present disclosure may be used to enforce restrictions on the type of data that may be associated with a ticket. For example, the priorities or categories allowed on a ticket may be restricted to those that have been properly defined and related to the applicable service contract. One way in which this feature can be implemented is to determine the service contract for the given ticket and reject reference fields that are not associated with the service contract at the time the ticket is created and/or modified.

As described above, SLAs may set forth a penalty, for example a pecuniary penalty, for SLA violations. Additionally, as described above, a given ticket may have multiple applied SLAs, any of which may set forth a penalty for violation. It may be possible to determine which SLAs have been applied to a given ticket by examining the SLA_Templates determined by the associated Attached_SLA associations. Rules and actions that will be executed against a ticket may be similarly determined. It may also be determined how much time remains in a ticket prior to one or more SLA violations.

The TTV described above may be used to determine the time remaining till SLA violations and the associated potential penalty. The TTV may be able to evaluate rules based on the current state of the ticket. For example, the TTV may execute the rules and conditions of the SLA prior to the time they come due without triggering the action associated with the rule. This may be used to determine if future execution of the rules and conditions would trigger an SLA violation and/or what the associated penalty would be. Where future execution of the rules and conditions would trigger an SLA violation, the ticket may be so noted, for example by placing a flag on the SLA_Template or action as disclosed above. The Attached_SLA may be updated with information indicating when a violation will occur and which rule is associated with the violation.

The TTV may evaluate tickets at multiple occasions. For example, the TTV may evaluate each ticket at inception and again when the state of a ticket is changed. For example, a database trigger may be used to trigger TTV evaluation of a ticket when the state of a ticket is changed. Alternatively, the TTV could periodically poll active tickets to determine if a state has changed since the last time the ticket was evaluated.

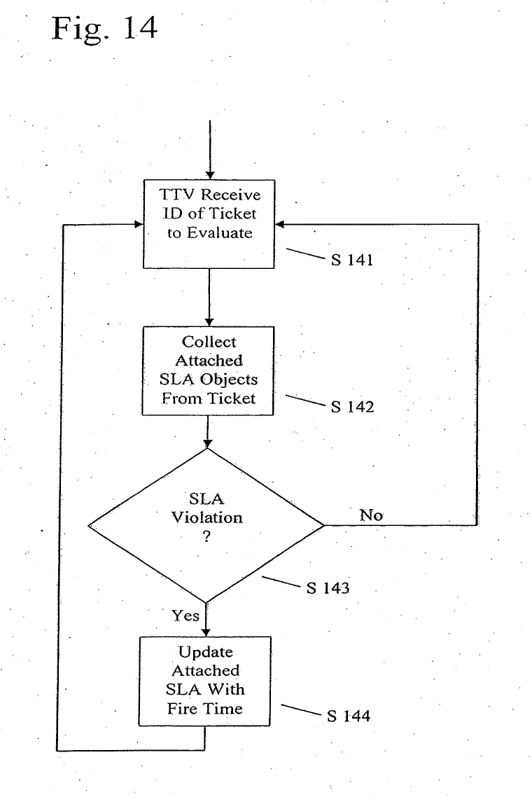

The TTV may use a process for evaluating the projected violation time of a particular ticket. FIG. 14 is a flow chart illustrating a process for evaluating the projected violation time of a ticket according to an embodiment of the present disclosure. The TTV may receive the id of a ticket to evaluate (Step S141). This may be accomplished, for example, by a database trigger or some other mechanism for alerting the TTV when the state of a ticket has been modified. The database trigger and/or other mechanism may also send a ticket id to the TTV when a state of an object associated to the ticket has been modified. For example, the operational status of an asset related to an open ticket may be modified and this change in status may also result in the TTV receiving the id of the ticket. The TTV may collect all Attached_SLA objects for the ticket (Step S142). In this context, “collect” may mean employing a SQL query or a set of programming constructs within a programming environment, for example C++, Java, etc., to retrieve the relevant objects from the data model. For each of the Attached_SLA objects, the SLA_Rule instances may be collected, for example by following the association to the SLA_Template. These rules may be sorted and evaluated by their fire time, for example in ascending order. The condition of each SLA_Rule may be evaluated to determine if resulting actions would lead to an SLA violation (Step S143). For example, the TTV may already have determined which actions result in an SLA violation, for example by comparing the action's id with id's of known actions that result in an SLA violation, or for example, by examining a flag associated with an action's object. Alternatively, another method of examination may be used. If the resulting action would lead to an SLA violation (Yes, Step S143) then the Attached_SLA object may be updated with the fire time of the SLA_Rule (Step S144). The remaining SLA_Rules may be evaluated.

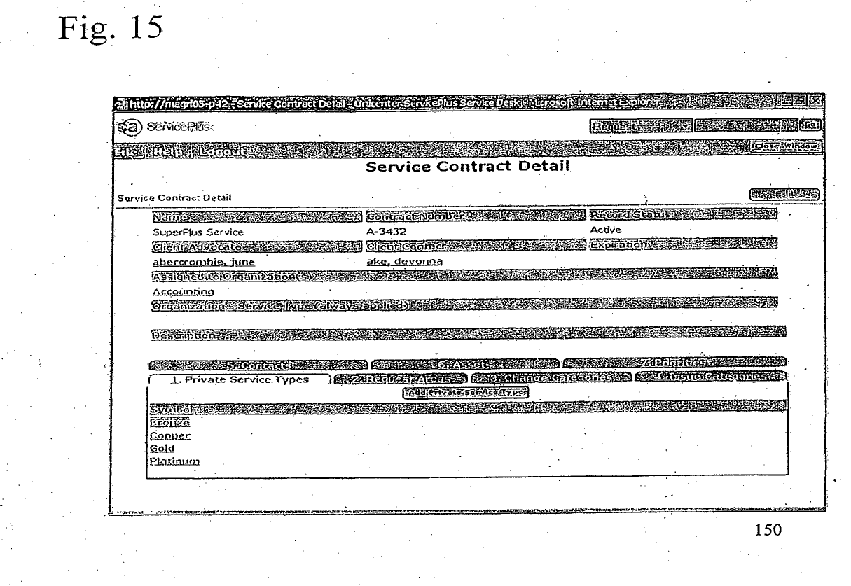

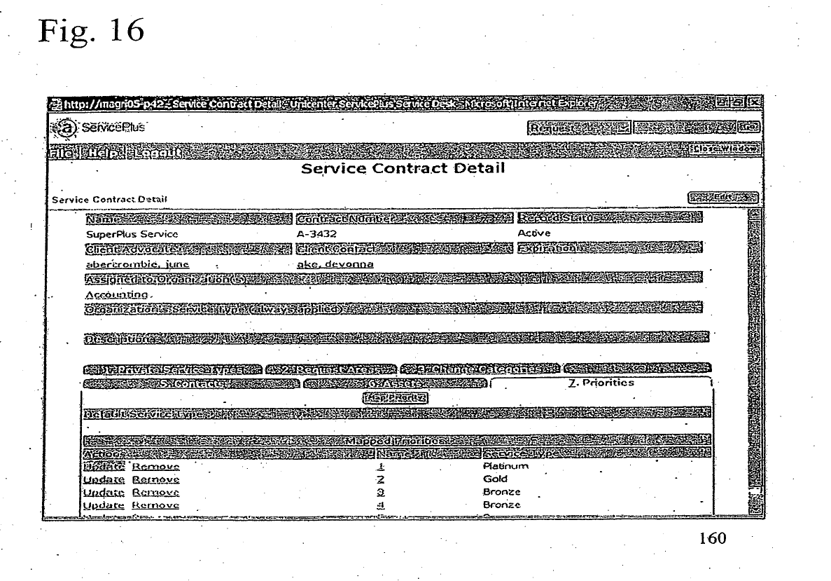

Embodiments of the present disclosure may use a graphical user interface to collect and display pertinent data objects. FIG. 15 is an example of a graphical user interface for displaying and/or receiving service contract details according to an embodiment of the present disclosure. A service contract graphical object 150 displays known details of a service contract. The service contract graphical object 150 may also be used to receive unknown details according to an embodiment of the present disclosure. The service contract graphical object 150 may have multiple sub-displays that may be activated by selecting a related sub-display tab. For example, private SLAs may be listed. FIG. 16 is an example of a graphical user interface for displaying and/or receiving service contract details according to an embodiment of the present disclosure. This service contract graphical object 160 demonstrates a selected “Priorities” tab and a listing of mapped priorities.

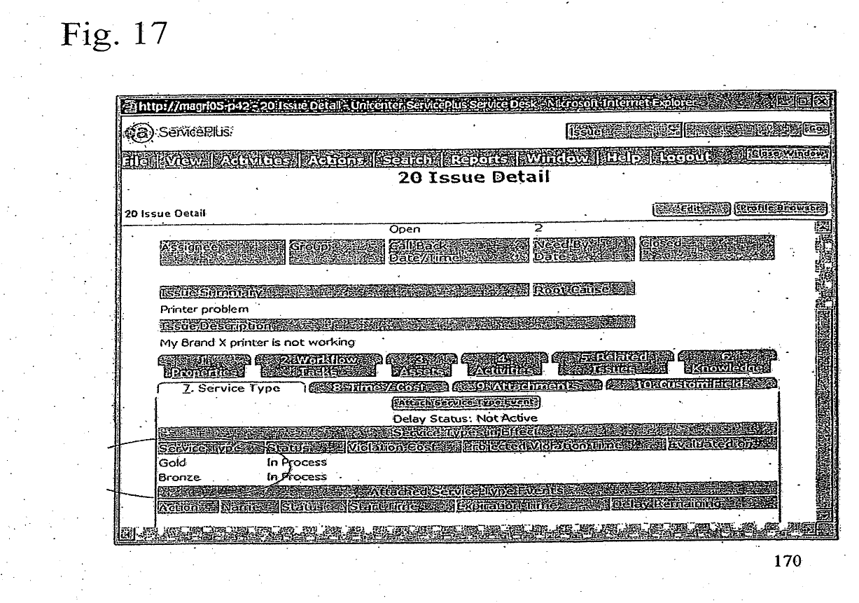

Graphical user interfaces may also be used to display and/or make changes to issues, for example, service tickets. FIG. 17 is an example of a graphical user interface for displaying and/or receiving issue details according to an embodiment of the present disclosure. Here, the issue detail graphical object 170 may be used to display and/or receive details relating to issues, for example, service tickets. Here, tickets with multiple attached SLAs may be viewed and/or adjusted.

Graphical user interfaces using graphical objects similar to those described above may be used to allow a user, for example a call center administrator, to view and add data objects to perform many embodiments of the present disclosure.

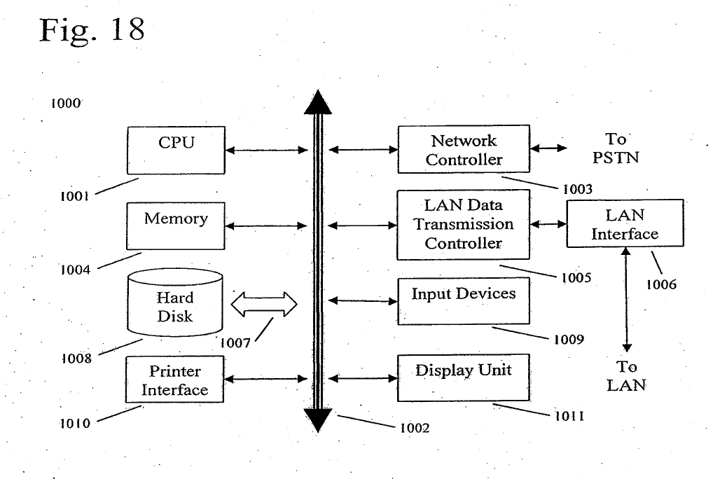

FIG. 18 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1-25. (canceled)

26. A method, comprising:
accessing a ticket object associated with a database, the ticket object comprising a plurality of ticket attributes;
determining, by a processor, a plurality of support level agreements (SLAs) that correspond to the ticket object based on one or more of the ticket attributes;
associating the ticket object with a plurality of attachment objects, each attachment object comprising:
an SLA attribute indicating one of the SLAs that corresponds to the ticket object; and
a time to violation (TTV) attribute comprising a time to violation for the SLA indicated by the SLA attribute; and
sorting the plurality of attachment objects according to the TTV attribute in order to facilitate determining an earliest time to violation for the ticket object.

27. The method of claim 26, wherein SLAs for one or more clients are stored in said database.

28. The method of claim 26, wherein SLAs for one or more service contracts are stored in said database.

29. The method of claim 26, further comprising:
associating each SLA with a contract expiration date; and
associating only unexpired SLAs with the ticket object.

30. The method of claim 26, wherein said SLAs have associated violation costs.

31. The method of claim 26, further comprising applying SLA rules to determine a period of time corresponding to the time to violation for the SLA.

32. The method of claim 26, additionally comprising determining one or more conditions for triggering a violation of said SLAs.

33. The method of claim 26, wherein said attributes comprise one or more of affected organization, priority or affected equipment.

34. The method of claim 26, further comprising automatically applying at least two of the plurality of SLAs corresponding to the ticket object.

35. The method of claim 26, further comprising:
modifying the ticket object with updated information;
determining whether any of the SLAs corresponding to the ticket object have been satisfied based on the updated information; and
deleting the attachment objects corresponding to the SLAs that have been satisfied.

36. The method of claim 26, wherein each of said plurality of SLAs is associated with a SLA rule, the SLA rule indicating a condition for applying each of said plurality of SLAs to the ticket object.

37. The method of claim 26, further comprising:
applying a first rule for a first contact associated with a first SLA of said plurality of stored SLAs; and
applying a second rule for a second contact associated with the first SLA of said plurality of stored SLAs.

38. A system, comprising:
an interface operable to:
access a ticket object associated with a database, the ticket object comprising a plurality of ticket attributes; and
one or more processors operable to:
determine a plurality of support level agreements (SLAs) that correspond to the ticket object based on one or more of the ticket attributes;
associate the ticket object with a plurality of attachment objects, each attachment object comprising:
an SLA attribute indicating one of the SLAs that corresponds to the ticket object; and
a time to violation (TTV) attribute comprising a time to violation for the SLA indicated by the SLA attribute; and
sort the plurality of attachment objects according to the TTV attribute in order to facilitate determining an earliest time to violation for the ticket object.

39. The system of claim 38, wherein SLAs for one or more clients are stored in said database.

40. The system of claim 38, wherein SLAs for one or more service contracts are stored in said database.

41. The system of claim 38, the one or more processors further operable to:
associate each SLA with a contract expiration date; and
associate only unexpired SLAs with the ticket object.

42. The system of claim 38, wherein said SLAs have associated violation costs.

43. The system of claim 38, the one or more processors further operable to apply SLA rules to determine a period of time corresponding to the time to violation for the SLA.

44. The system of claim 38, the one or more processors further operable to determine one or more conditions for triggering a violation of said SLAs.

45. The system of claim 38, wherein said attributes comprise one or more of affected organization, priority or affected equipment.

46. A computer system comprising:
one or more processors; and
a computer recording medium including computer executable code executable by one or more of the processors to:
access a ticket object associated with a database, the ticket object comprising a plurality of ticket attributes; and
determine a plurality of support level agreements (SLAs) that correspond to the ticket object based on one or more of the ticket attributes;
associate the ticket object with a plurality of attachment objects, each attachment object comprising:
an SLA attribute indicating one of the SLAs that corresponds to the ticket object; and
a time to violation (TTV) attribute comprising a time to violation for the SLA indicated by the SLA attribute; and
sort the plurality of attachment objects according to the TTV attribute in order to facilitate determining an earliest time to violation for the ticket object.

47. The computer system of claim 46, wherein SLAs for one or more clients are stored in said database.

48. The computer system of claim 46, wherein SLAs for one or more service contracts are stored in said database.

49. The computer system of claim 46, further operable to:
associate each SLA with a contract expiration date; and
associate only unexpired SLAs with the ticket object.

50. The computer system of claim 46, said SLAs have associated violation costs.

51. The computer system of claim 46, further operable to apply SLA rules to determine a period of time corresponding to the time to violation for the SLA.

52. The computer system of claim 46, further comprising code for determining one or more conditions for triggering a violation of said SLAs.

53. The computer system of claim 46, wherein said attributes comprise one or more of affected organization, priority or affected equipment.

54. A computer recording medium including computer executable code for managing support services, the computer executable code comprising:
code for accessing a ticket object associated with a database, the ticket object comprising a plurality of ticket attributes;
code for determining, by a processor, a plurality of support level agreements (SLAs) that correspond to the ticket object based on one or more of the ticket attributes;
code for associating the ticket object with a plurality of attachment objects, each attachment object comprising:
an SLA attribute indicating one of the SLAs that corresponds to the ticket object; and
a time to violation (TTV) attribute comprising a time to violation for the SLA indicated by the SLA attribute; and
code for sorting the plurality of attachment objects according to the TTV attribute in order to facilitate determining an earliest time to violation for the ticket object.
